(19) United States
(12) Patent Application Publication
(10) Pub. No.: US 2015/0348407 A1
(43) Pub. Date: Dec. 3, 2015

(54) Recommendation Engine Based on a Representation of the Local Environment Augmented by Citizen Sensor Reports

(71) Applicant: International Business Machines Corporation, Armonk, NY (US)

(72) Inventors: Priscilla Barreira Avegliano, Sao Paulo (BR); Carlos Henrique Cardonha, Sao Paulo (BR); Fernando Luiz Koch, Sao Paulo (BR); Takashi Imamichi, Tokyo (JP)

(73) Assignee: International Business Machines Corporation, Armonk, NY (US)

(21) Appl. No.: 14/290,342

(22) Filed: May 29, 2014

(51) Int. Cl. G08G 1/01; H04W 4/02

(52) U.S. Cl. CPC G08G 1/012; H04W 4/02

(57) ABSTRACT

An embodiment of the invention provides a method for using a recommendation engine that is based on a representation of the local environment augmented by citizen sensor reports. A traffic simulation is performed with a processor, the traffic simulation being based on input. A receiver receives new input from mobile electronic devices, the new input indicating an event. Current traffic conditions are identified; and, it is determined whether the current traffic conditions differ from estimated traffic conditions by a predetermined threshold. The estimated traffic conditions are a result of the traffic simulation. The traffic simulation is updated when the current traffic conditions differ from the estimated traffic conditions by the predetermined threshold.

### BACKGROUND

The present invention is in the field of systems, methods, and computer program products for determining the level of impact of a traffic incident.

Transportation is an area that receives a lot of attention in many of the world's cities. In situations where intelligent transportation systems (ITS) are used in an effort to manage traffic, city authorities often decide what type of sensors to use and where to position the sensors in order to obtain traffic data for traffic in the region. Multiple approaches exist, varying in accuracy, coverage and cost to install and maintain.

### SUMMARY OF THE INVENTION

An embodiment of the invention provides a method for using a recommendation engine that is based on a representation of the local environment augmented by citizen sensor reports. A traffic simulation is performed with a processor, the traffic simulation being based on input. A receiver receives new input from mobile electronic devices, the new input indicating an event. Current traffic conditions are identified; and, it is determined whether the current traffic conditions differ from estimated traffic conditions by a predetermined threshold. The estimated traffic conditions are a result of the traffic simulation. The traffic simulation is updated when the current traffic conditions differ from the estimated traffic conditions by the predetermined threshold.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a system including a recommendation engine according to an embodiment of the invention;

FIG. 2 illustrates a system for determining the level of impact of a traffic incident based on a representation of the local environment augmented by citizen sensor reports according to an embodiment of the invention;

FIG. 3 is a flow diagram illustrating a method for determining the level of impact of a traffic incident based on a representation of the local environment augmented by citizen sensor reports according to an embodiment of the invention; and

FIG. 4 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention includes a system and method that uses reports submitted through a citizen sensor platform in order to feed data and trigger the execution of a new traffic simulation. A traffic simulator manager is provided that can employ computational resources in a better way (e.g., simulations are conducted only when necessary) and using real-time data.

The method can be performed in operation centers (e.g., city, county, state, or region-wide) and other mechanisms for monitoring and coordination of urban and rural infrastructures. Infrastructure operators can perform simulations in order to foresee traffic conditions in the short, medium, and long term.

In at least one embodiment of the invention, the citizen sensor platform is a network of interconnected participatory citizens who provide intentional and non-intentional observations (or reports) about events occurring proximate their locations. The citizen sensor platform can instrument citizens and municipalities, interconnect parties, analyze related events, and provide recommendation and feedback reports.

Citizen sensor monitors can include hardware devices and/or applications on the mobile computing devices of end-users, which allow them to report situations on the spot. These reports can generate citizen sensor events that mark situations such as, for example, security threats, the presence of potholes, pollution in creeks, traffic jams, problems in public illumination, etc. Citizen sensing reports can be a combination of end-users' entered annotations with automated sensed information. These reports can be transmitted to a remote server where the data is stored, indexed, and grouped. This information can be used for running analysis and generating reports.

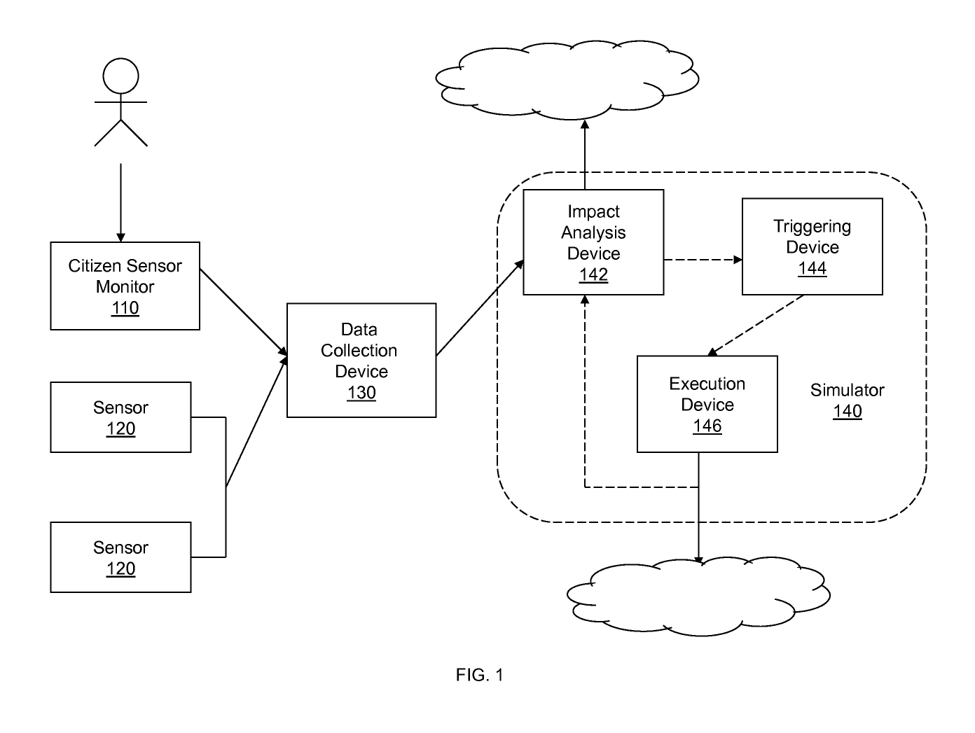

FIG. 1 illustrates a system including a recommendation engine based on a representation of the local environment augmented by citizen sensor reports according to an embodiment of the invention. A user U detects an event and creates a report describing the event using a citizen sensor monitor 110 (e.g., on a portable device of the user U). A report can include the data provided by the user U describing the event and additional contextual information, such as the geographical location of the user U. This information can be captured by the citizen sensor monitor 110 via the device's GPS (or via location based on cell towers, for example). The citizen sensor monitor application can send the collected report from the user's device to a remote server.

The system further includes sensors 120 of different types distributed throughout a geographic area. The sensors 120 can include can measure the speed of the cars, the presence of garbage, pollution, noise, lightning, precipitation, and/or temperature. The sensors 120 can periodically send the data they collect to the remote server. A data collection device 130 of the system aggregates all of the data received from the citizen sensor monitor(s) 110 and the sensors 120. The data collection device 130 can be housed within or connected to the remote server. As used herein, the term “device” includes a computer hardware apparatus (e.g., processor).

The system can include an impact analysis device 142 that analyzes the data in the data collection device 130 and generates a consolidated record or reports. In at least one embodiment, the impact analysis device 142, a triggering device 144, and an execution device 146 are positioned within a simulator 140 of the system. The impact analysis device 142 can recommend locations in which to deploy new sensors 120 based on the impact and the amount of reports.

The impact analysis device 142 can compare the current simulation output (i.e., the predicted traffic conditions for the present time) with the actual traffic conditions for the present time to determine the level of impact of the new events (i.e., the data from the data collection device 130). The triggering device 144 can receive and analyze the comparison results produced by the impact analysis device 142 and determine whether the current environmental/traffic conditions are significantly different from the predicted conditions. If this is the case, the triggering device 144 can trigger the execution of a new simulation. Taking into account the current conditions, the execution device 146 performs a new simulation.

Government agencies and/or companies that are responsible for traffic management can use the system. The citizen sensor monitor can be distributed to the population in order to enable people to send reports describing aspects of traffic; and thus, enhancing the range of information capture from places that might not be monitored by sensors. Data submitted to through the citizen sensor monitor can be accessed in order to extract the reports, identify emerging situations that may indicate significant changes in the current scenario, and to trigger a new simulation, whose results can be submitted to the managers.

The following provides an illustrative example of the use of the system shown in FIG. 1: a forecast of transit is generated, which predicts the possible behavior of vehicles in a city in a time-frame of 4 hours from the present time. An automobile accident occurs in a vital and primary street; and, a user immediately reports the accident using the citizen sensor monitor application 110. After a few moments, other users that are close to the accident's location (but on other streets, or outside of a predetermined radius from the accident location) send reports related to a traffic jam using the citizen sensor monitor application 110. At the same time, the sensors 120, which are disposed over the street affected and nearby, start reporting a reduction of the speed of automobiles. The level of impact of the event (i.e., automobile accident) increases and surpasses the threshold of impact of the system. This triggers a new simulation to forecast the behavior of transit, which considers the current situation caused by the automobile accident.

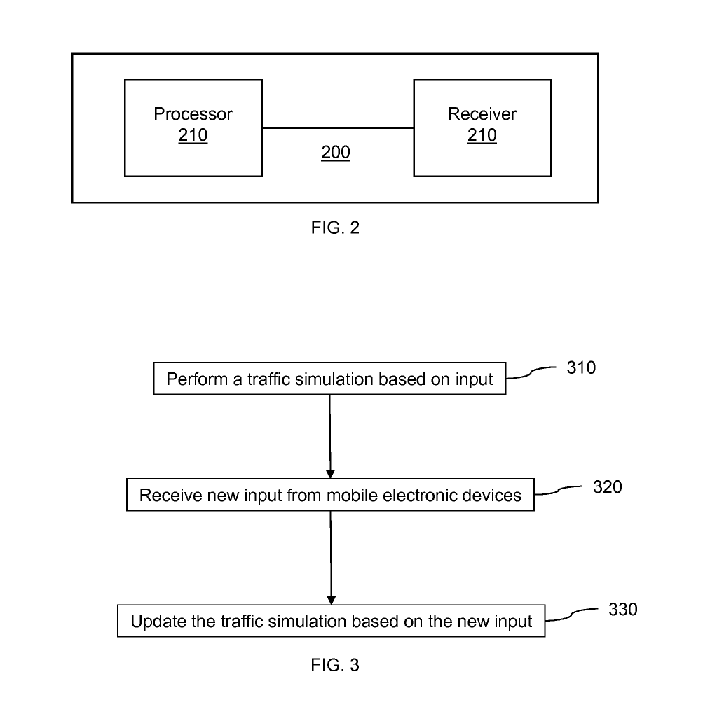

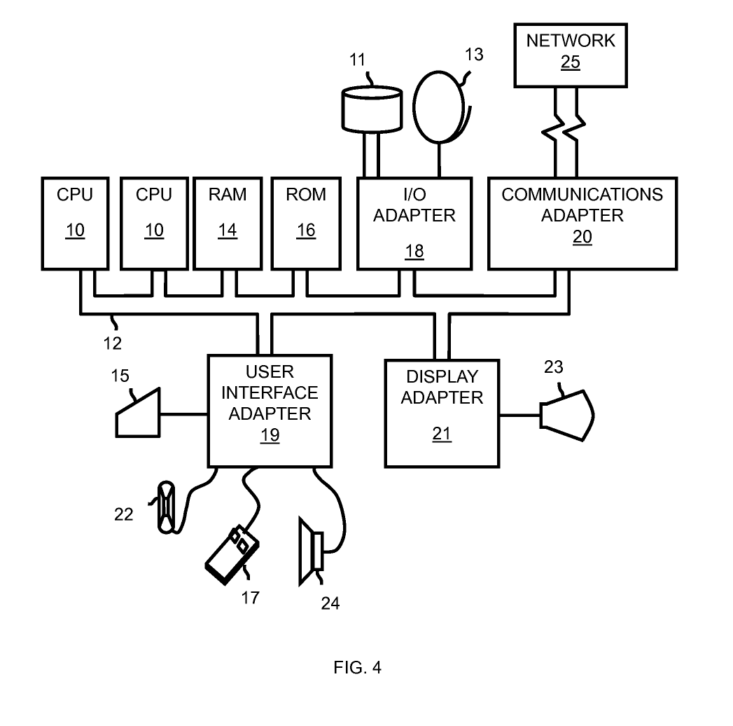

FIG. 2 illustrates a system 200 for determining the level of impact of a traffic incident based on a representation of the local environment augmented by citizen sensor reports according to an embodiment of the invention. The system 200 includes a processor 210 and a receiver 220 (e.g., antenna, network connection port) connected to the processor. FIG. 3 is a flow diagram illustrating a method for determining the level of impact of a traffic incident based on a representation of the local environment augmented by citizen sensor reports according to an embodiment of the invention, for example, using the system 200.

A traffic simulation is performed by the processor 210 (310), wherein the traffic simulation is based on input. The input can include, for example, the current number of individuals in the predefined area, the locations of the individuals in the predefined area, the traveling speeds of the individuals in the predefined area, the current number of individuals proximate the predefined area, the locations of the individuals proximate the predefined area, the traveling speeds of the individuals proximate the predefined area, and/or the history of traffic (e.g., the typical traffic for the predefined area during the specific time of day and day of week for which the traffic simulation is being currently performed).

The receiver 220 receives new input from mobile electronic devices (320), wherein the new input indicates an event. In at least one embodiment, the input and/or the new input include reports from individuals, wherein each report includes information about a traffic event that is occurring or has occurred proximate to an individual's location. The traffic event can include an event, occurrence, or incident that may affect traffic, such as, for example, an automobile accident, construction, a parade, a race, a demonstration or protest, street closures for security zones, a sporting event, or a concert.

In at least one embodiment of the invention, the information in the report includes an individual's location, the speed of movement of the individual, and/or the direction of movement of the individual. The report can include comments created by the individual such as, for example, the type of event, severity level, the presence or absence of first responders, etc. The individual can control when reports are sent to the receiver 220 (i.e., the reports are actively sent) or the reports can be passively sent by the individual's mobile device to the receiver 220 without the individual's actual knowledge (but with his or her previous consent).

Furthermore, the input and/or the new input can include data (e.g., precipitation, temperature, vehicle speed measured via radar, photographs, presence of garbage or debris, pollution, noise, lightning) from sensor devices positioned within a monitored area (i.e., the predefined area). The monitored area can include a predefined zone for which the traffic simulation is performed. The processor 210 updates the traffic simulation based on the new input (330).

In at least one embodiment of the invention, the processor 210 identifies current traffic conditions in a predefined area (e.g., with reports and/or sensors) and determines whether the current traffic conditions differ from estimated traffic conditions for the predefined area (i.e., the result of the traffic simulation that is based on the original input) by a predetermined threshold. This can be determined by comparing the current speed of individuals to an estimated speed of individuals, and/or by comparing the current volume of individuals to an estimated volume of individuals. The predetermined threshold can be set by a user or an administrator of the system 200. In this embodiment, the updating of the traffic simulation is only performed when the current traffic conditions differ from the estimated traffic conditions by the predetermined threshold (e.g., 10 miles per hour; 25% decrease and/or increase in estimated speeds).

Thus, for example, the results of the traffic simulation (that are based on the original input) predict that traffic on Main Street, between the intersection of 5th and Main to the intersection of 17th and Main will move at an average speed between 25 to 30 miles per hour for the time interval of 8:00 PM to 8:30 PM. The actual average speed for this stretch of Main Street at 8:02 PM is 29 miles per hour. Because the predetermined threshold is 5 miles per hour, the traffic simulation is not updated. At 8:14 PM, the actual average speed for this stretch of Main Street is 18 miles per hour. Because the difference between the predicted average speed and the actual average speed is greater than 5 miles per hour, the traffic simulation is updated. The current traffic conditions can be captured on demand by a user and/or administrator of the system 200 (e.g., the traffic simulator manager), at predetermined intervals, or when a predetermined amount of new input is received.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring now to FIG. 4, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
performing a traffic simulation with a processor, the traffic simulation being based on input;
receiving with a receiver new input from mobile electronic devices, the new input indicating an event;
identifying current traffic conditions;
determining whether the current traffic conditions differ from estimated traffic conditions by a predetermined threshold, the estimated traffic conditions being a result of the traffic simulation; and
updating the traffic simulation when the current traffic conditions differ from the estimated traffic conditions by the predetermined threshold.

2. The method according to claim 1, further comprising receiving with the receiver new input from other types of sensors.

3. The method according to claim 2, wherein said determining of whether the current traffic conditions differ from the estimated traffic conditions includes comparing at least one of:
current speed of individuals to estimated speed of individuals; and
current volume of individuals to estimated volume of individuals.

4. The method according to claim 2, further comprising determining the predetermined threshold with historical traffic data.

5. The method according to claim 1, wherein at least one of the input and the new input includes reports from individuals, each report including information about an event occurring proximate an individual's location.

6. The method according to claim 5, wherein the report is actively sent by the individual.

7. The method according to claim 5, wherein the information includes the geographical position of the individual.

8. The method according to claim 5, wherein the report includes comments created by the individual and additional information about the event's severity level.

9. A method comprising:
performing a traffic simulation with a processor, the traffic simulation being based on input;
receiving with a receiver new input from mobile electronic devices, the new input indicating an event; and
updating the traffic simulation with the processor based on the new input.

10. The method according to claim 9, further comprising:
identifying current traffic conditions;
determining whether the current traffic conditions differ from estimated traffic conditions by a predetermined threshold, the estimated traffic conditions being a result of the traffic simulation,
wherein said updating of the traffic simulation is only performed when the current traffic conditions differ from the estimated traffic conditions by the predetermined threshold.

11. The method according to claim 10, wherein said determining of whether the current traffic conditions differ from the estimated traffic conditions includes comparing:
current speed of individuals to estimated speed of individuals; and
current volume of individuals to estimated volume of individuals.

12. The method according to claim 10, further comprising determining the predetermined threshold with historical traffic data.

13. The method according to claim 9, wherein the input and the new input include reports from individuals, each report including information about an event occurring proximate an individual's location.

14. The method according to claim 13, wherein the report is passively sent by the individual.

15. The method according to claim 13, wherein the information includes the individual's location, a speed of movement of the individual, and a direction of movement of the individual.

16. The method according to claim 13, wherein the report includes comments created by the individual.

17. The method according to claim 9, wherein the input and the new input include data from sensor devices positioned within a monitored area, the monitored area including a predefined area for which the traffic simulation is performed.

18. A computer program product comprising:
a non-transitory computer readable storage medium;
first program instructions to perform a traffic simulation, the traffic simulation being based on input;
second program instructions to receive new input from mobile electronic devices, the new input indicating a traffic event;
third program instructions to update the traffic simulation based on the new input,
wherein said first program instructions, said second program instructions, and said third program instructions are stored on said computer readable storage medium.

19. The computer program product according to claim 18, further comprising:
fourth program instructions to identify current traffic conditions in a predefined area;
fifth program instructions to determine whether the current traffic conditions differ from estimated traffic conditions in the predefined area by a predetermined threshold, the estimated traffic conditions being a result of the traffic simulation,
wherein said third program instructions only update the traffic simulation when the current traffic conditions differ from the estimated traffic conditions by the predetermined threshold.

20. The computer program product according to claim 18, wherein at least one of the input and the new input includes reports from individuals, each report including information about an event occurring proximate an individual's location.
